(19) United States
(12) Patent Application Publication
(10) Pub. No.: US 2017/0043408 A1
(43) Pub. Date: Feb. 16, 2017

(54) CUTTER HOLDER FOR A MANUAL CUTTER-CHANGING SYSTEM

(71) Applicant: Ching-Ting CHEN, Taichung City (TW)

(72) Inventor: Ching-Ting CHEN, Taichung City (TW)

(21) Appl. No.: 14/826,020

(22) Filed: Aug. 13, 2015

(51) Int. Cl. B23B 31/02

(52) U.S. Cl. CPC B23B 31/02; B23B 2231/48

(57) ABSTRACT

A cutter holder has a holding segment and a flange. The holding segment has a triangular cross section, a first end, a second end, and a central hole. The second end is opposite the first end. The central hole is axially defined in the first end of the holding segment. The flange is disk-shaped, is coaxially formed on the second end of the holding segment, and has a periphery, an identifying hole, and a connecting hole. The identifying hole is radially defined in the periphery of the flange. The connecting hole is axially defined through the flange, communicates with the central hole in the holding segment, and has an inner thread formed in the connecting hole.

### BACKGROUND OF THE INVENTION

1. Field of the Invention

The present invention relates to an element for a cutting machine, and more particularly to a cutter holder for a manual cutter-changing system.

2. Description of Related Art

A cutting machine center may comprise multiple cutters held by multiple cutter holders respectively. Each cutter holder comprises a holding segment and a flange. The holding segment is applied to securely connect with a cutter base of the machine center. The flange is formed on one end of the holding segment. The machine center further comprises a cutter-changing system to allow the machine center to change different cutters for different cutting purposes. The conventional cutter-changing system includes different types, such as a manual cutter-changing system and an automatic cutter-changing system. To fit with an automatic cutter-changing system, multiple gripping recesses are defined in the flange of the cutter holder, such that the length of the flange of the cutter holder for an automatic cutter-changing system is longer than the flange of the cutter holder for a manual cutter-changing system. As such, the cutter holder for an automatic cutter-changing system cannot be directly applied to a manual cutter-changing system.

To overcome the shortcomings, the present invention tends to provide a cutter holder to be applied to a manual cutter-changing system.

### SUMMARY OF THE INVENTION

The main objective of the invention is to provide a cutter holder for a manual cutter-changing system.

The cutter holder has a holding segment and a flange. The holding segment has a triangular cross section, a first end, a second end, and a central hole. The second end is opposite the first end. The central hole is axially defined in the first end of the holding segment. The flange is disk-shaped, is coaxially formed on the second end of the holding segment, and has a periphery, an identifying hole, and a connecting hole. The identifying hole is radially defined in the periphery of the flange. The connecting hole is axially defined through the flange, communicates with the central hole in the holding segment, and has an inner thread formed in the connecting hole.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a cutter holder in accordance with the present invention;

FIG. 2 is another perspective view of the cutter holder in FIG. 1;

FIG. 3 is a cross sectional side view of the cutter holder in FIG. 1;

FIG. 4 is an end view of the cutter holder in FIG. 1;

FIG. 5 is a cross sectional side view of a second embodiment of a cutter holder in accordance with the present invention;

FIG. 6 is a perspective view of a cutter base of a machine center with the cutter holder in FIG. 5;

FIG. 7 is a cross sectional top view of the cutter base in FIG. 5; and

FIG. 8 is an operational cross sectional side view of a third embodiment of a cutter holder in accordance with the present invention.

### DETAILED DESCRIPTION OF PREFERRED EMBODIMENT

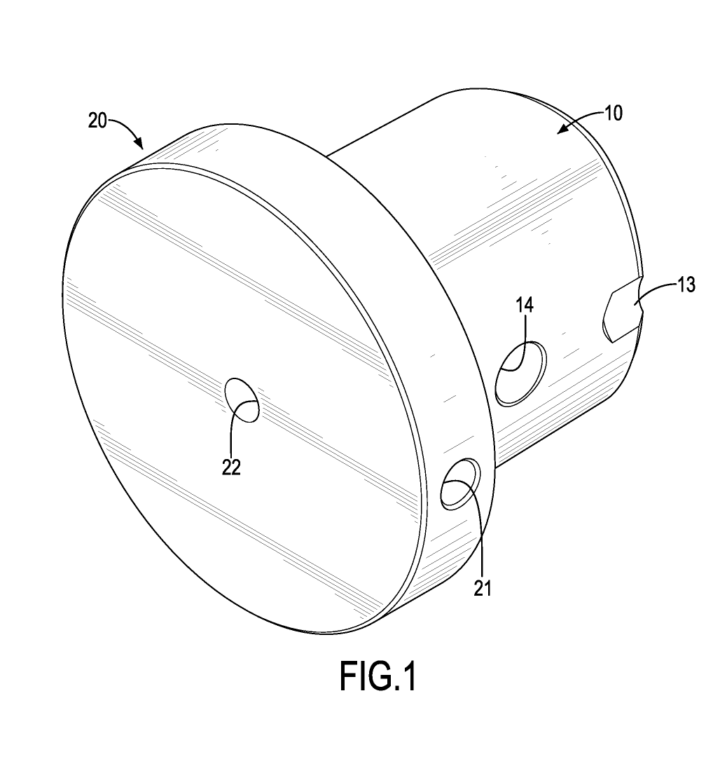

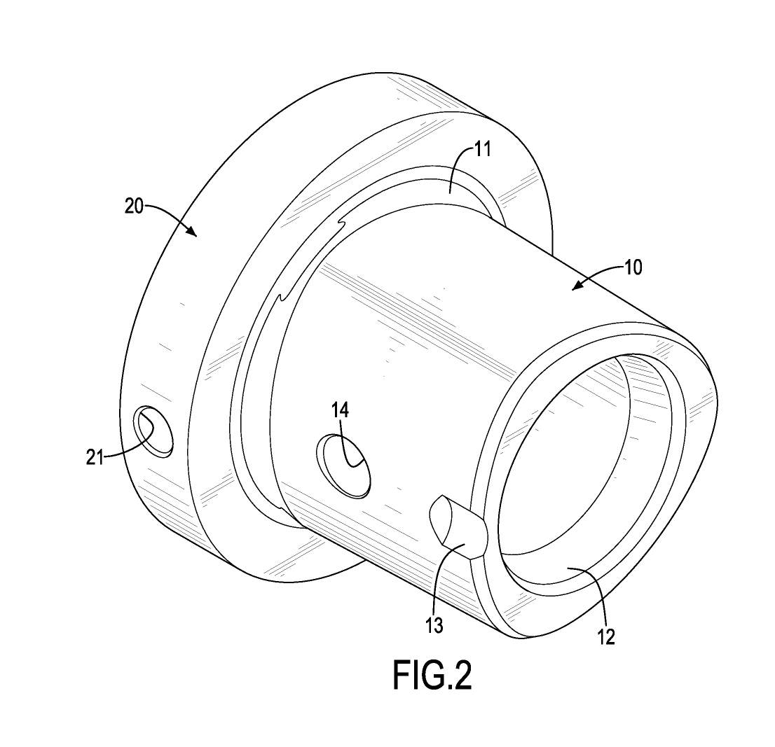

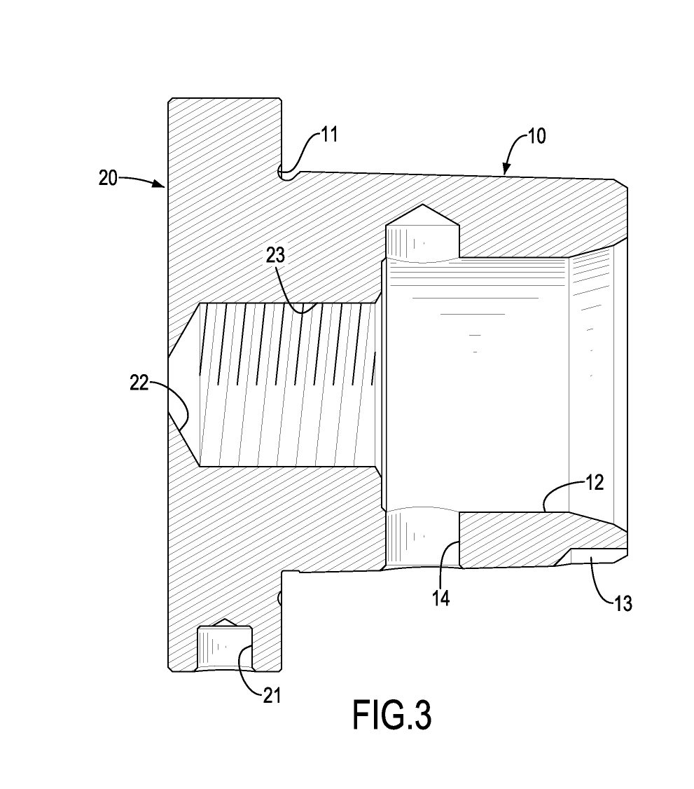

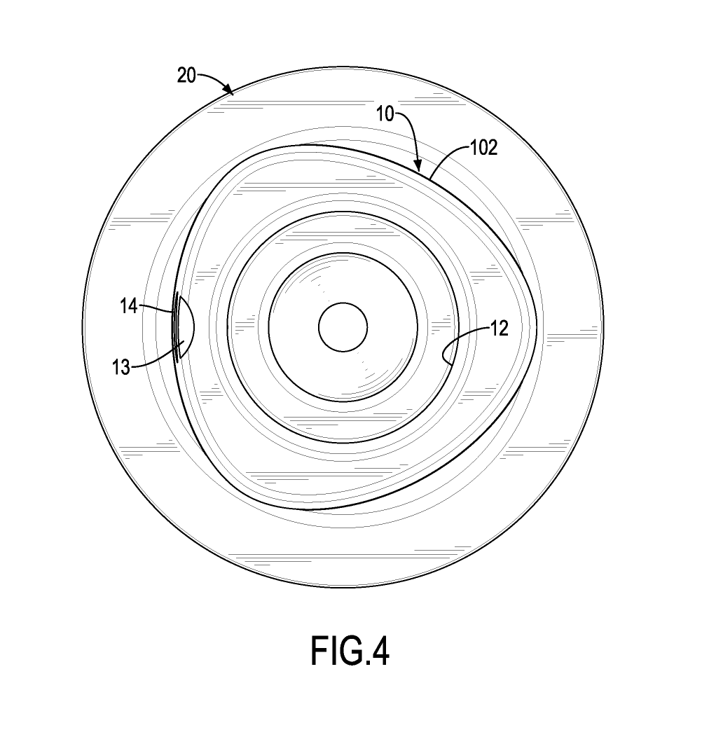

With reference to FIGS. 1 to 4, a cutter holder for a manual cutter-changing system in accordance with the present invention comprises a holding segment 10 and a flange 20.

The holding segment 10 has a triangular cross section, a first end, a second end, a central hole 12, an annular groove 11, a side hole 14, and an engaging notch 13. With the triangular cross section, three side surfaces 102 are formed and disposed around the holding segment 10. The second end is opposite the first end. The central hole 12 is axially defined in the first end of the holding segment 10. The annular groove 11 is defined around the second end of the holding segment 10. The side hole 14 is radially defined through one of the side surfaces 102 and communicates with the central hole 12 of the holding segment 10. The engaging notch 13 is defined in one of the side surfaces 102 and extends to the first end of the holding segment 10. Preferably, the engaging notch 13 is defined in the side surface 102 in which the side hole 14 is defined. Preferably, the side hole 14 and the engaging notch 13 are defined at a middle line of the side surface 102.

The flange 20 is a disk-shaped, is coaxially formed on the second end of the holding segment 10, and comprises a periphery, an identifying hole 21, and a connecting hole 22. The flange 20 is adjacent to the annular groove 11 of the holding segment 10. The identifying hole 21 is radially defined in the periphery of the flange 20. Preferably, the identifying hole 21 corresponds in position to the side surface 102 in which the side hole 14 and the engaging notch 13 are defined. The connecting hole 22 is axially defined through the flange 20, communicates with the central hole 12 in the holding segment 10, and has an inner thread 23 formed in the connecting hole 22.

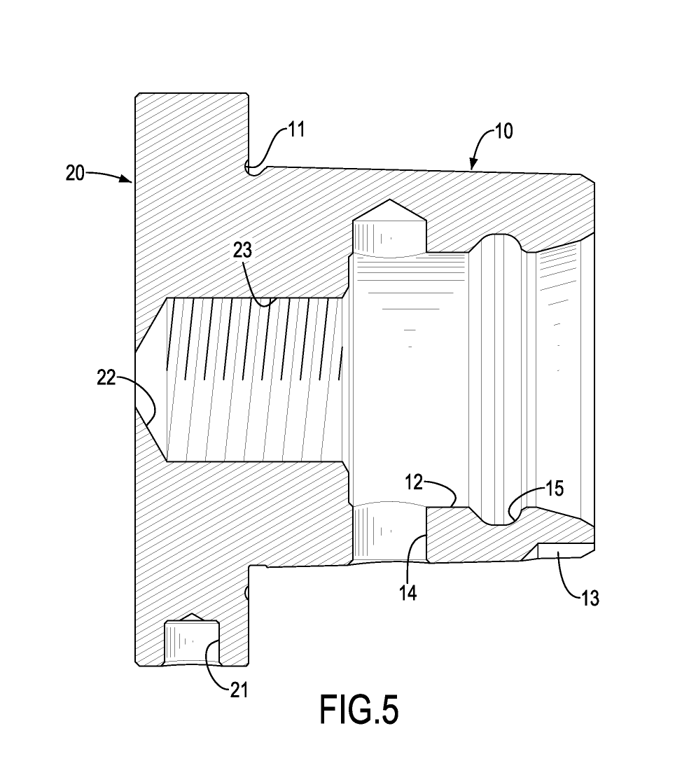

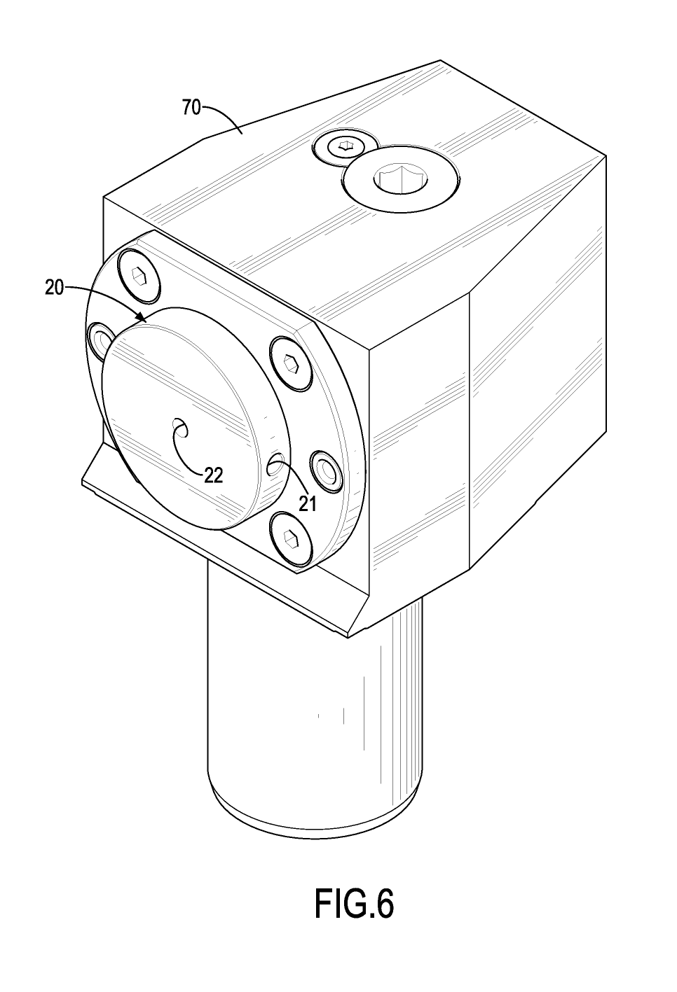

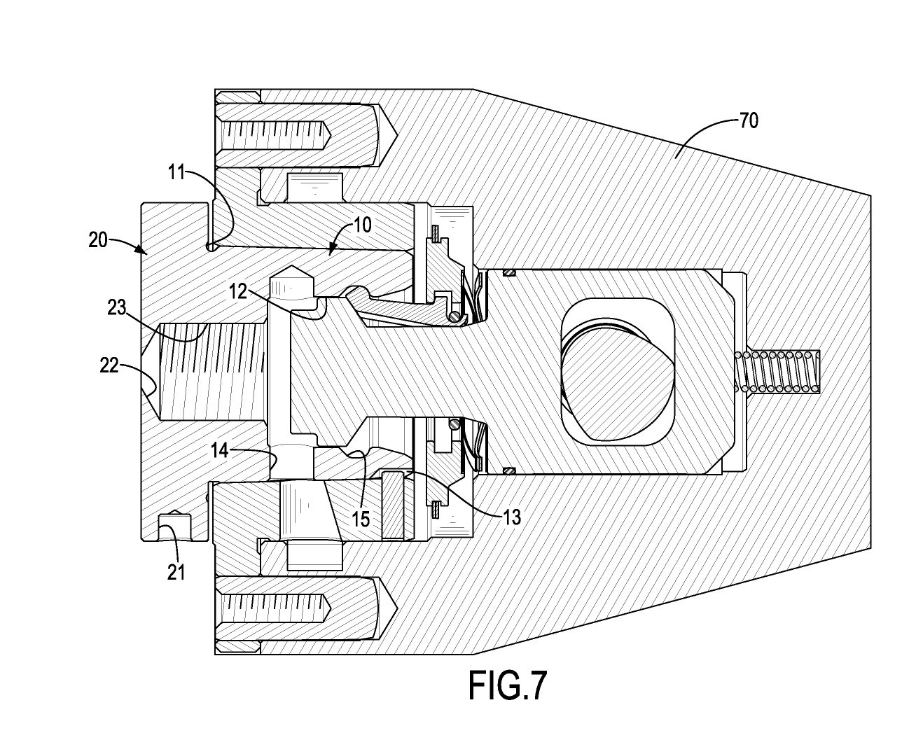

With reference to FIGS. 5 to 7, in the second embodiment, the central hole 12 in the holding segment 10 has an inner surface and an annular engaging groove 15 defined in the inner surface of the central hole 12 and being adjacent to the first end of the holding segment 10. With the engaging groove 15, the cutter holder can be securely connected to a cutter base 70 by the engagement between the engaging groove 15 and a clamping device in the cutter base 70.

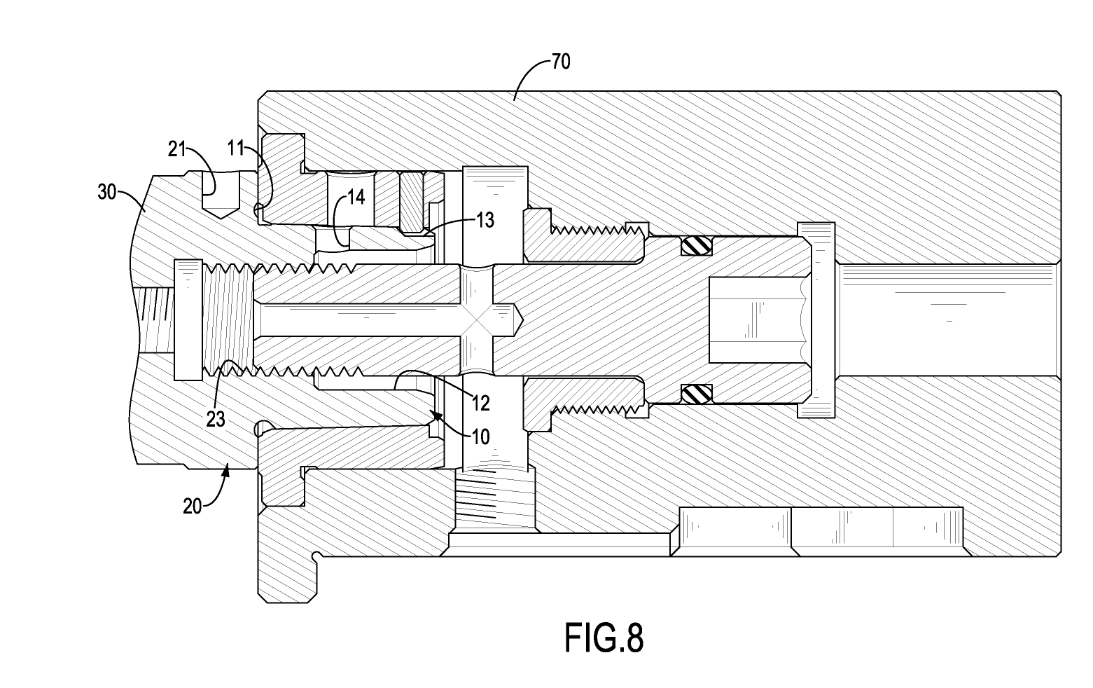

With reference to FIG. 8, in the third embodiment, the flange 20 further has a connection protrusion 30 formed on a side of the flange 20 opposite the holding segment 10.

In the first and third embodiments, with reference to FIGS. 1, 2 and 8, with engagement between the inner thread 23 of the connecting hole 22 and a threaded end of a linking rod, the cutter holder in accordance with the present invention can be securely connected to a cutter base 70 of a machine center. Because the flange 20 is not formed with multiple gripping recesses, the length of the flange 20 is shorter than the flange of a cutter holder for an automatic cutter-changing system, and the cutter holder of the present invention can be applied to a manual cutter-changing system in a machine center. In addition, with the arrangement of the identifying hole 21, the position of the cutter holder assembled on the cutter base can be clearly checked by a user.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cutter holder comprising:
a holding segment having
a triangular cross section;
a first end;
a second end opposite the first end; and
a central hole axially defined in the first end of the holding segment; and
a flange being disk-shaped, coaxially formed on the second end of the holding segment, and having
a periphery;
an identifying hole radially defined in the periphery of the flange; and
a connecting hole axially defined through the flange, communicating with the central hole in the holding segment, and having an inner thread formed in the connecting hole.

2. The cutter holder as claimed in claim 1, wherein the holding segment further has an annular groove defined around the second end of the holding segment and adjacent to the flange.

3. The cutter holder as claimed in claim 2, wherein
the holding segment has three side surfaces disposed around the holding segment;
the identifying hole in the flange corresponds in position to one of the side surfaces; and
the side surface corresponding to the identifying hole has a side hole radially defined through the side surface and communicating with the central hole of the holding segment.

4. The cutter holder as claimed in claim 3, wherein the side surface corresponding to the identifying hole further has an engaging notch defined in the side surface and extending to the first end of the holding segment.

5. The cutter holder as claimed in claim 4, wherein the central hole in the holding segment has an inner surface and an annular engaging groove defined in the inner surface of the central hole and being adjacent to the first end of the holding segment.

6. The cutter holder as claimed in claim 4, wherein the flange further has a connection protrusion formed on a side of the flange opposite the holding segment.
